(19) United States
(12) Patent Application Publication
(10) Pub. No.: US 2005/0018987 A1
(43) Pub. Date: Jan. 27, 2005

(54) Gas-filled optical fiber for wavelength calibration or measurement

(76) Inventors: Tobias Ruf, Renningen (DE); Emmerich Mueller, Aidlingen (DE)

Correspondence Address: Paul D Greeley;Ohlandt Greeley Ruggiero & Perle, One Landmark Square, 10th Floor, Stamford, CT, 06901-2682, US

(21) Appl. No.: 10/499,870

(22) PCT Filed: Jan. 19, 2002
(86) PCT No.: PCT/EP02/00487

(51) Int. Cl. G02B 6/20

(52) U.S. Cl. 385/125

(57) ABSTRACT

A gas cell for wavelength calibration or measurement comprises an optical fiber containing a gas having at least one absorption line for providing the wavelength calibration or measurement. The gas is preferably provided in a way that a sufficient part of an optical mode field distribution in the fiber is localized within the gas. The gas may be provided in a hole or an arrangement of holes in or along the fiber.

### BACKGROUND OF THE INVENTION

The present invention relates to wavelength calibration.

Currently, reference signals for wavelength calibration of instruments and systems used, e.g. in telecommunications, are obtained from optical absorption or emission lines of electronic or vibrational states of molecules, such as acetylene, HCN, or CO₂, which are contained in conventional glass cells. Details are disclosed e.g. in U.S. Pat. No. 6,249,343, U.S. Pat. No. 5,450,193, U.S. Pat. No. 5,521,703, or in http://www.boulder.nist.gov/div815/srms.htm.

### SUMMARY OF THE INVENTION

It is an object of the invention to provide an improved wavelength calibration. The object is solved by the independent claims. Preferred embodiments are shown by the dependent claims.

According to the present invention, an optical fiber is applied as a gas cell for wavelength calibration purposes. The optical fiber preferably comprises a hole or an arrangement of holes in or along the fiber, in which a sufficient part of the optical mode field distribution is localized. The hole or the arrangement of holes is filled with the gas for providing absorption lines for the wavelength calibration.

Mode-guiding in the fiber can be achieved preferably in two ways:
An arrangement of holes acts as an effective medium with lower refractive index than other regions of the fiber, e.g., the solid glass core of the fiber. In this case, the mode is usually guided in the glass of the fiber core, and only a small portion of the field distribution is localized in the holes. However, an arrangement of regions (or “shells”) with different hole densities can also be applied which mimics a profile of the effective index of refraction analogous to that in a conventional optical fiber. In this case, the fraction of the mode density localized in the holes will be larger.
An arrangement of holes acts as a photonic crystal which has very high reflectivity for modes guided in the region surrounded by the photonic crystal region. This region can be a very large diameter “hollow core” which then guides most of the mode intensity.

According to the invention, the holes in such fiber are filled with a defined gas or gas compound used as wavelength reference standard. The use of such fiber gas cells thus allows to enormously increase the interaction length of the light with the gas molecules compared to only a few cm in conventional gas cells. Therefore gases with rather low absorption, such as CO₂, can be used. This is especially useful in the telecommunications L band.

Further, the inventive fiber gas cells can be provided more compact, more flexible and better suited to fiber-optic instruments than the bulky cuvette-type conventional cells used today. Problems of pig-tailing and free-space connections across free path lengths of several cm can be significantly reduced.

Additionally, the volume of toxic gases, e.g. HCN, required for some applications can be significantly smaller. This has benefits for manufacturers, operators, and environment. Finally, fiber gas cells can be provided cheaper than conventional ones. Only a few meters of fiber are needed at most.

In a preferred embodiment for making the inventive fiber gas cells, air-filled hollow cores of “normal” photonic crystal fibers are filled with a desired gas or gas mixture. This can be achieved e.g. by pumping on one side and attaching a gas reservoir on the other side of the fiber. End pieces consisting of flat glass, microlenses as well as other optical, source or detection elements could be attached, for example by gluing or arc welding methods.

Alternatively, small pieces of frozen gas crystals or small amounts of liquid gas can be inserted in the evacuated fiber that is then sealed. The fiber fills with gas as the crystals or the liquid evaporate.

Since gas filling of holes with small diameters might suffer from the large resistance of the very narrow channels, the whole fiber growth process is preferably performed in another embodiment in an environment (e.g. under pressure) of the desired gas or gas mixture.

In a preferred embodiment, the optical fiber is provided in accordance with a hollow-core fiber as disclosed by J. C. Knight et al., Optics Letters 21, 1547 (1996), a “holey” fiber as disclosed by M. Ibanescu et al., Science 289, 415 (2000), or a photonic crystal fiber as disclosed by J. Broeng et al., Danish Opt. Soc. News, p. 22, June 2000 or J. Broeng et al., J. Opt. A: Pure Appl. Opt. 1, 477 (1999) or J. Broeng et al., Science 285, 1537 (1999.

Other applicable fiber structures are disclosed e.g. in WO-A-0022466, WO-A-9964903, WO-A-9964904, U.S. Pat. No. 6,301,420, WO-A-0142831, WO-A-0065386, or WO-A-0016141.

For providing a wavelength reference measurement, the inventive fiber filled with gas having known absorption wavelengths is preferably coupled to a wavelength source providing the stimulus for the gas-filled fiber. A wavelength response signal of the gas-filled fiber in response to the applied stimulus is detected and analyzed. Comparing the detected wavelength response signal with the known absorption wavelengths then allows calibrating the provided wavelength analysis using the known absorption wavelengths. Calibration schemes and setups as disclosed e.g. in the aforementioned U.S. Pat. No. 6,249,343, U.S. Pat. No. 5,450,193, U.S. Pat. No. 5,521,703, or in http://www.boulder.nist.gov/div815/srms.htm, as well as other known wavelength measurement, control and calibration techniques, can be applied accordingly.

Further preferred embodiments are:

The individual holes of the fiber gas cell are not all uniformly filled with the same gas used for wavelength calibration. Other possibilities include: (1) Some of the holes are filled with the reference gas and some holes are under vacuum (“empty”); (2) some of the holes are filled with the reference gas and others are filled with another gas, e.g. air. The gas cell, however, should be provided in a way that interaction of the light with the reference gas is strong enough to allow for wavelength measurement.
Different holes of the fiber gas cell are filled with different reference gases, e.g., C₂H₂ and CO₂ in one and the same fiber. This allows the simultaneous measurement of reference wavelengths in different spectral regions, according to the gases used, in a single fiber gas cell.
At least two fiber gas cells having a certain length and being filled with different reference gases, e.g., C₂H₂ and CO₂, are spliced together, thereby forming a new fiber gas cell having a greater length. This arrangement allows the simultaneous measurement of reference wavelengths in different spectral regions, according to the gases used, in a single fiber gas cell.
A fiber gas cell having at least one end piece consisting of a lens or another means to improve the coupling of this fiber gas cell to other fiber-optical components and systems. The at least one end is mechanically coupled or fusion spliced to the fiber gas cell.
Fiber gas cell in combination with an optical system, such as but not limited to a source or receiver of optical power, to perform wavelength reference measurements.
An integrated system of fiber gas cell with light source and/or detector mounted directly onto the fiber ends for easy incoupling and/or detection of optical power.
Fiber gas cell using the broadband light from the spontaneous emission (SSE) of a laser as input illumination. Such a unit may, e.g., replace the combination of light-emitting diode (LED) and conventional gas cell used for wavelength calibration of an optical spectrum analyzer (OSA), since the SSE could be obtained from a tunable laser that is oftentimes used together with an OSA. In an OSA using heterodyne technology, the SSE could also be obtained from a built-in laser source.

### BRIEF DESCRIPTION OF THE DRAWINGS

Other objects and many of the attendant advantages of the present invention will be readily appreciated and become better understood by reference to the following detailed description when considering in connection with the accompanied drawings. Features that are substantially or functionally equal or similar will be referred to with the same reference sign(s).

FIG. 1 shows a setup for providing a wavelength reference measurement according to the present invention.

FIG. 2 illustrates, in cross sectional view, in principle an embodiment of the fiber 10 according to the present invention.

### DETAILED DESCRIPTION OF THE INVENTION

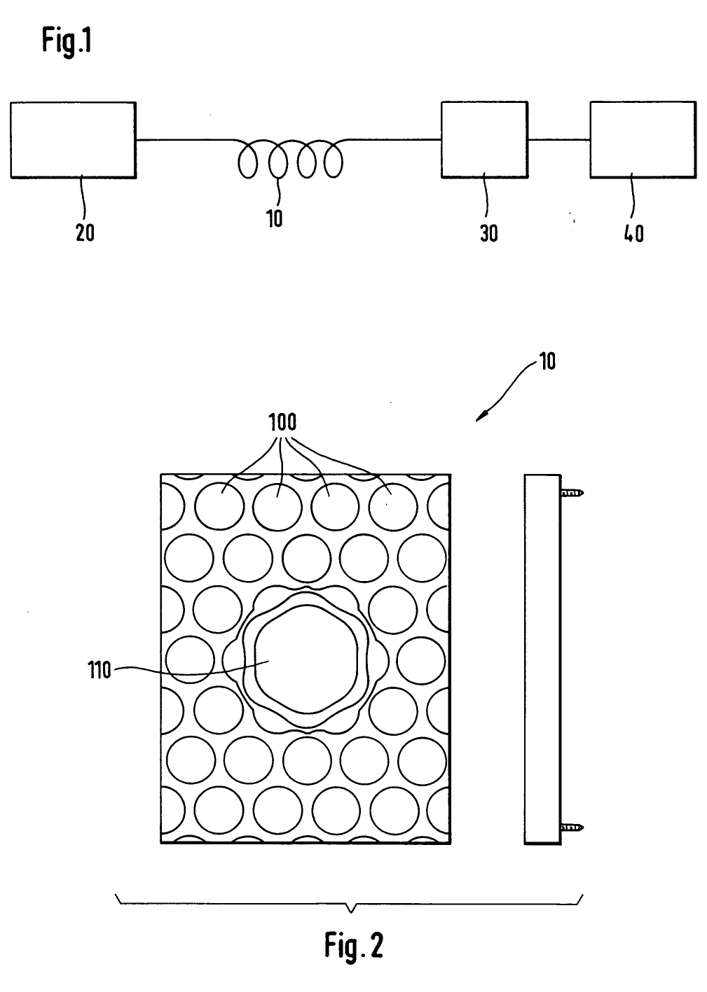

In FIG. 1, a fiber 10 filled with a gas having known absorption wavelengths is coupled to a wavelength source 20 providing a stimulus signal for the gas-filled fiber 10. A wavelength response signal of the gas-filled fiber 10 in response to the applied stimulus is detected by a detector 30 and analyzed by an analyzing unit 40. The analyzing unit 40 compares the detected wavelength response signal with the expected absorption wavelengths known for the gas in the fiber 10. Differences between actually measured absorption wavelengths and the expected absorption wavelengths then allow calibrating the provided wavelength analysis of the analyzing unit 40.

FIG. 2 illustrates in principle, in cross-sectional view, an applicable embodiment of the fiber 10, as known from: J. Broeng et al., Danish Opt. Soc. News, p. 22, June 22. The regular pattern of circles 100 denotes holes filled with gas. The large cross-sectional area 110 in the center of the figure, having exemplary hexagonal symmetry, represents the hollow core of the fiber 10 and is also filled with gas. The almost circular gray-scale image denotes the field distribution of the fundamental guided mode of the fiber that occurs mainly in the gas-filled region.

1. An optical fiber containing a gas providing at least one absorption line for providing a wavelength calibration or measurement.

2. The optical fiber of claim 1, wherein the gas is provided in a way that a sufficient part of an optical mode field distribution in the fiber is localized within the gas.

3. The optical fiber of claim 1, wherein the gas is provided in a hole or an arrangement of holes in or along the fiber, in which a sufficient part of the optical mode field distribution is localized.

4. The optical fiber according to claim 1, wherein an arrangement of holes in the fiber acts as an effective medium with lower refractive index than other regions of the fiber.

5. The optical fiber according to claim 1, wherein an arrangement of regions or shells with different hole densities provides a profile of the effective index of refraction analogous to that in a conventional optical fiber.

6. The optical fiber according to claim 1, wherein an arrangement of holes acts as a photonic crystal which has high reflectivity for modes guided in the region surrounded by the photonic crystal region.

7. The optical fiber according to claim 1, wherein some holes in the fiber are filled with the reference gas and some holes are substantially under vacuum or filled with a different gas.

8. The optical fiber according to claim 1, wherein different holes of the fiber are filled with different reference gases.

9. The optical fiber according to claim 1, further comprising at least one end piece, preferably a lens, for better coupling to other fiber-optical components or systems.

10. A gas cell for wavelength calibration or measurement comprising an optical fiber containing a gas providing at least one absorption line for providing a wavelength calibration or measurement.

11. A gas cell for wavelength calibration or measurement comprising a plurality of optical fibers containing a gas providing at least one absorption line for providing a wavelength calibration or measurement, each having a certain length and being filled with a respective reference gas, wherein the plurality of optical fibers are spliced or otherwise coupled together.

12. An optical system for perform a wavelength reference measurement, comprising:
an optical fiber or a gas cell for wavelength calibration or measurement comprising an optical fiber containing a gas providing at least one absorption line for providing a wavelength calibration or measurement, adapted for receiving an optical stimulus signal,
a receiver adapted for receiving a response signal of the optical fiber to the applied optical stimulus signal, and
a processing unit adapted for determining in the response signal one or more wavelengths absorbed by the optical fiber or the gas cell.

13. The optical system of claim 12, wherein the processing unit is adapted to comparing the one or more determined absorption wavelengths with known one or more absorption wavelengths for providing a wavelength calibration.

14. A method for making an optical fiber or a gas cell containing a gas providing at least one absorption line for providing a wavelength calibration or measurement, comprising the step of:
filling at least one hole or air-filled hollow core of a photonic crystal fiber with a desired gas or gas mixture.

15. The method of claim 14, further comprising the steps of:
pumping on one side of the fiber, and
attaching a gas or liquid gas reservoir on the other side of the fiber.

16. The method of claim 14, further comprising the steps of:
inserting pieces of frozen gas crystals or liquid gas in the evacuated fiber, and
sealing the fiber.

17. The method of claim 14, being performed in an environment of the desired gas or gas mixture.
